(19) United States
(12) Patent Application Publication
(10) Pub. No.: US 2024/0021918 A1
(43) Pub. Date: Jan. 18, 2024

(54) Propagation barrier with reinforcing filling material and method of producing same

(71) Applicant: ZENTRUM FÜR SONNENENERGIE- UND WASSERSTOFF-FORSCHUNG BADEN-WÜRTTEMBERG GEMEINNÜTZIGE STIFTUNG, Stuttgart (DE)

(72) Inventors: Bruno BAUSCH, Augsburg (DE); Daniel BECHER, Ehingen (DE); Olaf BÖSE, Ulm (DE)

(73) Assignee: ZENTRUM FÜR SONNENENERGIE- UND WASSERSTOFF-FORSCHUNG BADEN-WÜRTTEMBERG GEMEINNÜTZIGE STIFTUNG, Stuttgart (DE)

(21) Appl. No.: 18/256,873

(22) PCT Filed: Nov. 28, 2022
(86) PCT No.: PCT/EP2022/083528

§ 371 Date: Jun. 9, 2023

(30) Foreign Application Priority Data
Nov. 29, 2021 (DE) 10 2021 131 311.2

(51) Int. Cl. H01M 10/658; C08L 5/04; C08K 3/26; C09K 5/14; H01M 50/209; H01M 10/0525; B32B 5/18; B32B 27/06; B32B 3/26; F16L 59/02

(52) U.S. Cl. CPC H01M 10/658; C08L 5/04; C08K 3/26; C09K 5/14; H01M 50/209; H01M 10/0525; B32B 5/18; B32B 27/065; B32B 3/266; F16L 59/02; C08L 2203/20; C08K 2003/265; B32B 2266/122; B32B 2307/306; B32B 2307/7246; B32B 2457/10; B32B 2571/00; B32B 2266/02; B32B 2264/104; B32B 2307/7376

(57) ABSTRACT

The present invention relates to a barrier for preventing the propagation of a thermal event within a multi-cell battery module (so-called “propagation barrier”), comprising a heat-absorbing protective layer based on a hydrogel and a reinforcing filling material. Furthermore, the invention relates to a battery module which comprises the barrier, and to the use of the barrier to compensate for volume fluctuations within a battery module. In addition, a method for producing the propagation barrier is also specified.

The present invention relates to a barrier for preventing the propagation of a thermal event within a multi-cell battery module (so-called “propagation barrier”), which comprises a heat-absorbing protective layer based on a hydrogel and a reinforcing filling material. Furthermore, the invention relates to a battery module which comprises the barrier, and to the use of the barrier to compensate for volume fluctuations within a battery module. In addition, a method for producing the propagation barrier is also specified.

### TECHNICAL BACKGROUND AND PRIOR ART

In principle, thermal events can occur in all battery types. One of the most feared thermal events is battery thermal runaway. This can occur when the rate at which the battery generates heat exceeds the rate at which the heat can be dissipated. If a critical temperature is exceeded, the heat-producing process taking place inside the battery intensifies itself and the battery heats up to several hundred degrees Celsius within a very short time. At the same time, there is an extreme increase in pressure in the cell, which can result in an explosive escape of decomposition gases and a fire.

In multi-cell battery modules, the danger emanating from such a thermal event is increased severalfold. The spacing between the individual cells does not provide sufficient protection against thermal runaway propagation. Due to the high temperature that occurs in the cell affected by the thermal runaway, the adjacent cells also heat up above the critical temperature. Accordingly, the thermal runaway of a single cell can easily lead to the destruction of the entire battery module.

Lithium-ion batteries are particularly susceptible to thermal runaway. These batteries have a significantly higher energy density than other battery types and can release decomposition gases, if any, with a large proportion of oxygen, which can lead to even higher temperatures in the event of a failure. In fields of application, in which the space requirement of the battery module is critical, many battery manufacturers have started to increase the packing density of the lithium-ion cells to the maximum. As a result, there is only little space available for barriers to prevent the propagation of thermal events, which in many cases results in insufficient thermal insulation between the cells.

Against this background, different barrier materials for batteries are proposed in the prior art.

WO 2010/017169 A1 also deals with the issue of thermal runaway in multi-cell battery packs, especially lithium-ion battery packs, and proposes strategies for preventing a thermal event from being transmitted from one battery cell to an adjacent battery cell. A propagation barrier with a hydrogel as the heat-absorbing material is specified for this purpose. The hydrogel is kept in a flexible bag or a dimensionally stable container and placed in the battery module. The flexible pouch packaging conforms to the shape of the battery cells to ensure heat transfer from the battery cell to the hydrogel. The container can be custom made to also make contact with the cell surface. However, both are in need of improvement. The element can only function as a barrier to a limited extent. In the embodiment where the hydrogel is provided in a pouch packaging, there is no spacer between the cells that would survive the thermal runaway of an adjacent cell. Once the water has evaporated and the matrix material of the hydrogel has decomposed, adjacent cells can come into direct contact with each other. In the embodiment in which the hydrogel is provided in a container, the cells are not in direct contact with one another, however, the container walls made from a solid material form a thermal bridge, through which the thermal event continues to unfold after the water contained in the hydrogel has evaporated.

### OBJECT OF THE INVENTION

Based on this prior art, the object of the present invention was to provide a barrier with a dimensionally stable heat-absorbing material that is at least as effective in terms of preventing the propagation of a thermal event within a multi-cell battery module as conventional batteries. In particular, a barrier was to be developed that can also effectively compensate for the dilatation effects of battery cells. In addition, a corresponding battery module was to be specified. Furthermore, the present invention has set itself the goal of specifying a method for producing such a barrier.

### SUMMARY OF THE INVENTION

This object is achieved by the barrier according to claim 1, its use according to claim 11, the battery module according to claim 12 and the method according to claim 14.

According to the invention there is provided a barrier for preventing the propagation of a thermal event within a multi-cell battery module, comprising a heat-absorbing protective layer containing 70.0-97.5% by weight of a hydrogel and 2.5-30.0% by weight reinforcing filling material, wherein the hydrogel comprises a matrix material and water and the reinforcing filling material is dispersed in the hydrogel.

Due to the high proportion of hydrogel, the heat-absorbing protective layer can absorb heat particularly effectively and thermally shield adjacent cells in the battery module from one another. The higher the proportion of hydrogel, the higher the amount of water that is contained and which evaporates with the development of heat and the better the heat dissipation.

A reinforcing filling material in the context of the present invention is understood as meaning a particulate material which is preferably present in pourable and/or free-flowing form, in particular as a powder or granules. Accordingly, a preformed structure, for example a carrier matrix in the form of a lattice structure and/or honeycomb structure, does not fall under the term “reinforcing filling material”.

The presence of at least 2.5% by weight reinforcing filling material ensures the dimensional stability of the heat-absorbing protective layer. This dimensional stability is expressed in particular by the fact that the heat-absorbing protective layer is self-supporting. At the same time, the maximum proportion of 30% by weight filling material ensures that the protective layer retains a certain flexibility.

In addition, the reinforcing filling material can prevent the formation of thermal bridges between adjacent cells in the battery module. Due to the dispersion, the filling material is statistically distributed in the heat-absorbing protective layer and can still act as an insulator between adjacent cells in the event of a thermal event, even after the water has evaporated and the matrix material has decomposed.

In a preferred embodiment, the heat-absorbing protective layer in the barrier according to the invention contains 70.0-95.0% by weight of a hydrogel and 5.0-30.0% by weight reinforcing filling material.

The addition of 5 to 30% by weight of reinforcing filling material minimizes water leakage from the hydrogel during thermal cycling (freeze/thaw) of the barrier. This makes the barrier suitable for use in batteries and battery modules that are used outdoors and are exposed to winter conditions.

More specifically, in the barrier of the present invention, the heat-absorbing protective layer contains 80.0-92.5% by weight of a hydrogel and 7.5-20.0% by weight reinforcing filling material.

The reinforcing filling material preferably consists of particles with an aspect ratio in the range from 0.5 to 10, the aspect ratio being measured according to ISO standard 9276-6. Particularly preferably, the reinforcing filling material consists of spherical particles.

In one embodiment, the particles are inorganic particles. The particles preferably have an average particle size d₅₀ from 1 nm to 5 mm, preferably from 100 nm to 5 mm, in particular from 1000 nm to 2 mm, the average particle size d₅₀ being measured according to ISO standard 13320-1.

The heat-absorbing protective layer can be wrapped or enclosed, for example welded, in a foil impermeable to water vapor. In contrast to conventional propagation barriers, packaging in a foil is not necessary to prevent the hydrogel from spreading unintentionally. The foil is only intended to protect the heat-absorbing protective layer against long-term water loss, i.e., counteract the diffusion loss of water.

The foil impermeable to water vapor is preferably a polymer foil, a metal foil or a laminate of the aforementioned foils, particularly preferably with a foil thickness of less than 0.3 mm, in particular less than 0.2 mm. The polymer foil can be selected in particular from the group consisting of polyethylene (PE), polypropylene (PP), polyvinylidene fluoride (PVDF), polychlorotrifluoroethylene (PCTFE), polyphenylene sulfide (PPS), ethylene-tetrafluoroethylene copolymer (ETFE), polyurethanes (PU), polyamides (PA), polyesters, in particular polethylenetherephthalate (PET), and combinations thereof. The metal foil is preferably an aluminum foil.

In an advantageous embodiment, the matrix material consists of at least 85% by weight of a natural polymer. The natural polymer is preferably based on biogenic raw materials. The term “biogenic raw materials” within in the meaning of the present invention includes organic raw materials that have been produced in agriculture and forestry or isolated from bacterial, yeast, fungal, aquaculture or marine cultures, as well as organic raw materials of animal origin, namely those that are anyway occur as a by-product of animal slaughter and require recycling. Furthermore, “biogenic raw materials” within the meaning of the present invention are biodegradable according to DIN EN 13432. The biogenic raw materials are opposed to fossil raw materials and petrochemical based energy sources, including substances that have been obtained through chemical synthesis processes and/or are not biodegradable.

The matrix material preferably consists of 85% natural polymer selected from the group consisting of alginate, agar-agar, starch, starch derivatives, κ-carrageenan, ι-carrageenan, pectin, gellan, scleroglucan, and combinations thereof.

Although the origin and composition of the polysaccharides mentioned above are known to those skilled in the art, individual polysaccharides are discussed in more detail below:

Alginate is the main structural component of the cell walls of brown macroalgae. It is a linear copolymer of uronic acid β-D-mannuronate (M) and its C-5 epimer α-L-guluronate (G) containing homopolymeric blocks of 1,4-linked consecutive M units (polyM) or G-units (polyG) or blocks of alternating M and G units (polyMG). Alginate can be used in the form of its salts, e.g., alkali or alkaline earth metal salts, or in esterified form, e.g., in the form of an alkyl ester, e.g., a methyl ester.

Agar-agar is obtained also from the cell walls of algae, such as blue or red algae. It essentially corresponds to a mixture of the polysaccharides agarose and agaropectin, with agarose preferably making up 60-80% by weight of the mixture. Agarose is a polysaccharide made from D-galactose and 3,6-anhydro-L-galactose linked together glycosidically. Agaropectin is a polysaccharide of β-1,4- and α-1-3-glycosidically linked D-galactose and 3,6-anhydro-L-galactose. About every tenth galactose residue is esterified at O-6 with sulfuric acid and contains additional sulfate moieties. Agar-agar is a very particularly preferred naturally occurring gelling agent within the meaning of the present invention. This is due to the fact that a hydrogel based on agar-agar is dimensionally stable at temperatures below about 85° C. and only releases water above this temperature.

κ-Carrageenan consists of repeating monomers of D-galactose-4-sulfate and 3,6-anhydro-D-galactose. ι-Carrageenan differs from κ-carrageenan only in that the 3,6-anhydro-D-galactose unit carries an additional sulfate group in the C-2 position. Both carrageenans occur in nature as the basic substance of the cell walls of a large number of red algae.

Gellan is a polysaccharide comprising a repeat unit consisting of a rhamnose, a glucuronic acid and two glucose repeat units esterified with acetic acid and glyceric acid. It can be produced, for example, by the fermentation of carbohydrates by the bacterial strain Pseudomonas elodea.

Scleroglucan is a β-1,3-glucan that carries a glucose moiety as a side chain on average on every third sugar. Scleroglucan is preferably obtained from fungal cultures.

The matrix material of the hydrogel can consist of at least 85% by weight, preferably at least 95% by weight, particularly preferably at least 99% by weight, calcium alginate.

The matrix material can also comprise up to 15% by weight, preferably up to 5% by weight, in particular up to 1% by weight, thickener. By adding a thickener, the mechanical properties of the heat-absorbing protective layer can be adjusted in an even broader range.

In particular, flexibility or compressibility can be adjusted at will and with a view to the requirements of the respective application. This is advantageous, for example, to compensate for dilation effects in the battery cells that can occur during the charging and discharging process and as a result of aging.

The thickener is preferably selected from the group consisting of cellulose derivatives, in particular hydroxyethyl cellulose; hydroxypropyl cellulose; hydroxypropyl methyl cellulose and/or carboxycellulose, guar gum, xanthan gum, or mixtures thereof. These materials are also “biogenic raw materials” and are part of a sustainable approach to battery production. In particular, they help reduce the CO₂ footprint associated with the barrier production process.

The reinforcing filling material is preferably selected from the group consisting of hydroxyapatite, calcium carbonate, calcium sulfate; aluminum oxide, magnesium oxide, hydrates of the aforementioned substances, and mixtures thereof. The aforementioned materials have low thermal conductivity and are available in suitable particle sizes. In the event that hydrates are used as filling materials, the heat-absorbing property of the protective layer is further enhanced since the water of crystallization can also absorb heat and evaporate.

The hydrogel may contain or consist of 5-30% by weight matrix material and 70-95% by weight water. Particularly preferably, the hydrogel contains or consists of 5-20% by weight matrix material and 80-95% by weight water.

The heat-absorbing protective layer has a thickness of 0.25-10.0 mm, preferably a thickness of 1.5-3.0 mm, in particular a thickness of 1.5-2.5 mm. As a result, the barrier takes up as little space as possible in the battery module and still fulfills its function, namely thermally shielding the battery cells from one another after installation in a battery module.

In order to further adjust compressibility, passage openings can be provided in the heat-absorbing protective layer. In a state where no external force is acting on the propagation barrier, the passage openings are gaps or holes in the protective layer, i.e., cavities that are not filled with material. When force is applied, the material mixture from which the protective layer is made can be displaced into the cavities of the passage openings. This results in a high compressibility of the protective layer compared to a solid material. Reversible and irreversible changes in volume of the battery cells contained in a battery module can be compensated.

The proportion by volume of the passage openings in the protective layer is preferably between 1% and 90%, more preferably between 8% and 80%, particularly preferably between 10% and 75%, in particular between 20% and 60%.

Each passage opening preferably has a cross-sectional area of 0.025 mm²-50.0 mm², more preferably 0.5 mm²-8.0 mm², in particular 2.0 mm²-5.0 mm².

The cross-sectional area can—but does not have to—be identical for all passage openings. It must be taken into account here that an identical cross-sectional area of all passage openings can possibly simplify the production process.

The through-openings may have cross-sectional shapes selected from the group consisting of circular, elliptical, superelliptical, star-shaped, slit-shaped, crescent-shaped, diamond-shaped, polygonal-shaped, and combinations thereof. The use of non-circular cross-sections leads to specific force-displacement or force-compression curves of the propagation barrier. For example, by using star-shaped passage openings, a force-displacement curve can be realized in which a certain level of compression is achieved with the action of very little force, but then considerably more force is required to further compress the barrier.

In a preferred embodiment, the through-openings are unevenly distributed, in particular in such a way that in a first area, which is closer to the center of the propagation barrier than to its edge, there is a surface density ρ₁ of through-openings, and in a second area, which is closer to the edge of the propagation foil than to the center thereof, there is a surface density ρ₂ of passage openings, where ρ₁≠ρ₂. In general, the distribution of the passage openings in the protective layer should be adapted to the structure and the geometry of the battery module. This means that the greater areal density of passage openings is present where the adjacent battery cells have a greater reversible and irreversible dilatation during operation. In the context of the present invention, areal density is to be understood as meaning the proportion of the cross-sectional area of passage openings relative to a surface element of the propagation barrier.

Furthermore, the cross section of the passage openings can be constant over the thickness of the protective layer or, alternatively, either narrow or widen.

It is evident from the above statements that a further aspect of the present invention is the use of the barrier to compensate for volume fluctuations within a battery module. The volume fluctuations can be attributed to reversible dilation effects during charging and discharging processes or to irreversible dilation effects due to aging of the battery cells.

The invention also provides a battery module comprising a plurality of battery cells and at least one of the barriers described above. The barrier is preferably arranged in the battery module between two adjacent battery cells.

Since lithium-ion cells are particularly susceptible to thermal runaway, it is also advantageous if the battery cells in the battery module are lithium-ion cells.

Finally, the invention also specifies a method for producing the barrier according to the invention. In the process, a heat-absorbing protective layer is first produced.

The production of the heat-absorbing protective layer preferably comprises the following steps i)-iii):
i) sodium alginate powder, a reinforcing filling material and water are mixed to form a viscous mass,
ii) the mass is poured onto a flat surface or into a mold with a planar bottom, and
iii) the cast mass is wetted with a solution containing calcium ions or immersed in a solution containing calcium ions.

After curing, the mass can then be dabbed and wrapped and/or sealed in a foil impermeable to water vapor. This manufacturing process is simple and does not require any expensive tools. In addition, the process has a low CO₂ footprint.

### DESCRIPTION OF PREFERRED EMBODIMENTS

Preferred embodiments of the invention are explained in more detail with reference to the figures and the following example, without wishing to limit the invention thereto. In particular, the following example describes only one production route for the barriers according to the invention. It can be assumed that the barriers can also be manufactured industrially by extrusion.

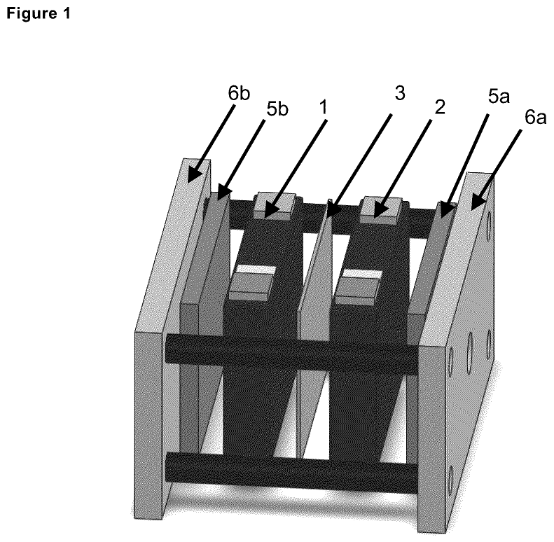

FIG. 1 shows the arrangement of a barrier 3 according to the invention in a battery (-test) module comprising two battery cells 1 and 2. 5a and 5b are thermal insulations, which prevent, after the proactive triggering of the thermal event, that a part the thermal energy released is absorbed by the clamping plates 6a and 6b, which have a certain heat capacity. This avoids measurement errors. The clamping plates ensure the mechanical cohesion of the module. The measuring points at which the temperature is measured are on the front and back of each cell.

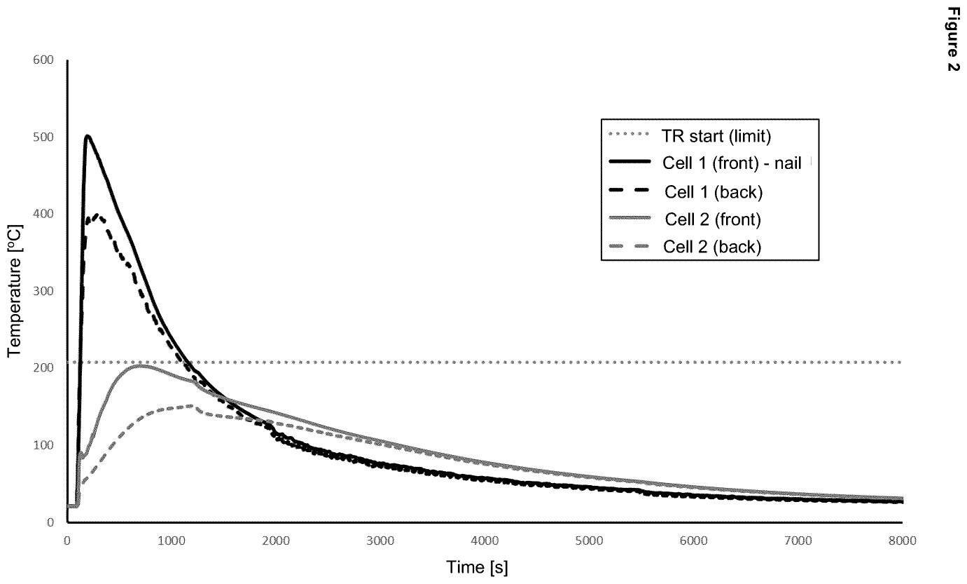

FIG. 2 shows the temperature profile of cells 1 and 2 after nail penetration of cell 1. From the temperature profile it can be deduced that barrier 3 according to the invention successfully shields cell 2 thermally. This prevents cell 2 from reaching the critical temperature.

### EXAMPLE

### 1) Production of the Barrier According to the Invention

80% by weight water, 15% by weight sodium alginate and 5% by weight filling material (calcium carbonate) are mixed for about 3 minutes. The resulting mixture is applied in a flat and open mold with a thickness of about 2.3 mm. The mixture of thickness 2.3 mm is immersed with the mold in an aqueous CaCl₂ solution (5% by weight) for 30 seconds. This creates a heat-absorbing protective layer comprising a flexible, homogeneous hydrogel with a thickness of 2.6 mm. Compared to the dimensions of the mold in which the mixture was applied, the heat absorbing protective layer has shrinkage of about 5% in both length and width. The protective layer contains about 80% by weight water.

Finally, the protective layer is welded into a foil impermeable to water vapor (foil thickness 0.15 mm).

### 2) Nail Penetration Test

The barrier produced was placed in a gap between two fully charged 40 Ah NMC 111 prismatic cells. The arrangement corresponds to the illustration in FIG. 1. The thermal runaway of the cell 1 was then provoked by penetrating it with a nail. The temperature development at the front and back of both cells was measured and recorded for a period of 7000 seconds (see FIG. 2). The barrier prevented thermal runaway from cell 1 to cell 2.

1-15. (canceled)

16. A barrier for preventing propagation of a thermal event within a multi-cell battery module, comprising a heat-absorbing protective layer containing 70.0-97.5% by weight hydrogel and 2.5-30.0% by weight reinforcing filling material,
wherein the hydrogel comprises a matrix material and water and the reinforcing filling material is dispersed in the hydrogel.

17. The barrier according to claim 16, wherein the protective layer is enclosed in a foil impermeable to water vapor.

18. The barrier according to claim 17, wherein the foil impermeable to water vapor comprises a polymer foil, a metal foil, or a laminate thereof.

19. The barrier according to claim 17, wherein the foil impermeable to water vapor is selected from the group consisting of polyethylene (PE), polypropylene (PP), polyvinylidene fluoride (PVDF), polychlorotrifluoroethylene (PCTFE), polyphenylene sulfide (PPS), ethylenetetrafluoroethylene copolymer (ETFE), polyurethanes (PU), polyamides (PA), polyesters, and combinations thereof.

20. The barrier according to claim 16, wherein the matrix material comprises at least 85% natural polymer, wherein said natural polymer is selected from the group consisting of alginate, agar-agar, starch, starch derivatives, κ-carrageenan, ι-carrageenan, pectin, gellan, scleroglucan, and combinations thereof.

21. The barrier according to claim 16, wherein the matrix material comprises at least 85% by weight calcium alginate.

22. The barrier according to claim 16, wherein the matrix material further comprises up to 15% by weight thickener.

23. The barrier according to claim 22, wherein the thickener is selected from the group consisting of hydroxyethyl cellulose; hydroxypropyl cellulose; hydroxypropylmethylcellulose and/or carbox-ycellulose, guar gum, xanthan gum, or mixtures thereof.

24. The barrier according to claim 16, wherein the reinforcing filling material is selected from the group consisting of hydroxyapatite, calcium carbonate, calcium sulfate; aluminum oxide, magnesium oxide, hydrates of the aforementioned substances, and mixtures thereof.

25. The barrier according to claim 16, wherein the hydrogel comprises 5-30% by weight matrix material and 70-95% by weight water.

26. The barrier according to claim 16, wherein the protective layer has a thickness of 0.25-10.0 mm.

27. The barrier according to claim 16, wherein the protective layer has a thickness of 1.5-3.0 mm.

28. The barrier according to claim 16, wherein the heat-absorbing protective layer has passage openings, wherein the volume proportion of the passage openings in the protective layer is between 20% and 60%.

29. The barrier according to claim 16, wherein the heat-absorbing protective layer has passage openings, wherein each passage opening has a cross-sectional area of 0.5 mm²-8.0 mm².

30. The barrier according to claim 16, wherein the heat-absorbing protective layer has passage openings, wherein each passage opening has a cross-sectional area of 2.0 mm²-5.0 mm².

31. A method for preventing the propagation of a thermal event within a multi-cell battery module comprising:
a) providing a multi-cell battery module comprising a barrier of claim 1, wherein the barrier is arranged between a first battery cell and an adjacent second battery cell;
b) generating heat in the first battery cell;
c) absorbing the generated heat into the barrier thereby thermally shielding the adjacent second battery from the generated heat.

32. The method of claim 31, wherein the heat-absorbing protective layer has passage openings, wherein the volume proportion of the passage openings in the protective layer is between 1% and 90%, and the method comprises displacing a portion of the hydrogel and the reinforcing filling material into the passage openings when force is applied, thereby compensating for volume fluctuations.

33. A battery module, comprising a plurality of battery cells and at least one barrier according to claim 16, wherein the barrier is arranged between two adjacent battery cells.

34. The battery module according to claim 33, wherein the battery cells are lithium-ion cells.

35. A method of manufacturing a barrier according to claim 16, in which a heat-absorbing protective layer is produced, wherein the heat absorbing protective layer is produced by
i) mixing sodium alginate powder, a reinforcing filling material and water to form a viscous mass,
ii) pouring the mass onto a flat surface or into a mold with a planar bottom, and
iii) wetting the cast mass with a solution containing calcium ions or immersing it in a solution containing calcium ions.
